(19) United States
(12) Patent Application Publication
(10) Pub. No.: US 2023/0118640 A1
(43) Pub. Date: Apr. 20, 2023

(54) METHODS AND SYSTEMS FOR EXTRACTING SELF-CREATED TERMS IN PROFESSIONAL AREA

(71) Applicant: METIS IP (SUZHOU) LLC, Suzhou (CN)

(72) Inventor: Yan LI, Suzhou (CN)

(73) Assignee: METIS IP (SUZHOU) LLC, Suzhou (CN)

(21) Appl. No.: 16/763,214

(22) PCT Filed: Mar. 25, 2020
(86) PCT No.: PCT/CN2020/081083

§ 371 Date: Dec. 26, 2022

(51) Int. Cl. G06F 40/289; G06F 40/284; G06F 40/205

(52) U.S. Cl. CPC G06F 40/289; G06F 40/284; G06F 40/205

(57) ABSTRACT

The present disclosure discloses a method for extracting one or more self-created terms in a professional area. The method may include extracting one or more candidate terms from a text; determining first data representing an occurrence of each of the one or more candidate terms in the text; determining one or more lemmas of the each of the one or more candidate terms; determining second data representing an occurrence of each of the one or more lemmas in a general corpus; determining third data representing an occurrence of each of the one or more lemmas in a professional area corpus; and determining, based on reference data, a possibility that the each of the one or more candidate terms is a self-created term, wherein the reference data includes the first data, the second data, and the third data.

### CROSS-REFERENCE TO RELATED APPLICATIONS

This application is a U.S. national stage under 35 U.S.C. § 371 of International Application No. PCT/CN2020/081083, filed on Mar. 25, 2020, designating the United States of America, the entire contents of which are incorporated herein by reference.

### TECHNICAL FIELD

The present disclosure relates to the field of natural language processing, and in particular, to methods and systems for term extraction.

### BACKGROUND

With the development of Internet technology and other new technologies, the numbers of terms in some professional areas have been continuously expanded and updated. Current needs for term extraction can no longer be met by using a traditional process of manually collecting terms in the professional areas, making it necessary to automatically identify and extract terms. However, some terms (also referred to as self-created terms) in certain professional areas are created by users themselves, and these self-created terms are different from existing professional terms and are difficult to collect automatically. Therefore, it is desirable to develop methods and systems to effectively identify and extract self-created terms in a professional area, and such methods and systems are of great importance in information extraction, information retrieval, machine translation, and text classification, etc.

### SUMMARY

In one aspect of the present disclosure, a method for extracting one or more self-created terms in a professional area is provided. The method may include extracting one or more candidate terms from a text; determining first data representing an occurrence of each of the one or more candidate terms in the text; determining one or more lemmas of the each of the one or more candidate terms; determining second data representing an occurrence of each of the one or more lemmas in a general corpus; determining third data representing an occurrence of each of the one or more lemmas in a professional area corpus; and determining, based on reference data, a possibility that the each of the one or more candidate terms is a self-created term, wherein the reference data includes the first data, the second data, and the third data.

In some embodiments, the extracting one or more candidate terms in a text may include obtaining a plurality of segmented word combinations by performing word segmentation on the text; removing, from the plurality of segmented word combinations, one or more segmented word combinations present in the professional area corpus; and determining the one or more candidate terms from the removed segmented word combinations.

In some embodiments, the reference data further may include a word-class structure.

In some embodiments, the first data may include a first frequency, wherein the first frequency includes at least one of a frequency of the each of the one or more candidate terms in different portions of the text and a frequency of the each of the one or more candidate terms in the text.

In some embodiments, the first data may further include a first count, wherein the first count includes a count of the each of the one or more candidate terms in different portions of the text and/or a count of the each of the one or more candidate terms in the text.

In some embodiments, the determining, based on reference data, a possibility that the each of the one or more candidate terms is a self-created term may include: determining the possibility that the each of the one or more candidate terms is the self-created term according to a rule.

In some embodiments, the second data may include a second frequency of each of the one or more lemmas in the general corpus, and the third data may include a third frequency of each of the one or more lemmas in the professional field corpus. The rule may include that: the first frequency exceeds a first threshold; the second frequency is less than a second threshold; and a ratio of the third frequency to the second frequency exceeds a third threshold.

In some embodiments, the rule may further include that a matching degree of the word-class structure of the each of the one or more candidate terms with a preset word-class structure exceeds a fourth threshold.

In some embodiments, the determining, based on reference data, a possibility that the each of the one or more candidate terms is a self-created term may include: determining the possibility that the each of the one or more candidate terms is the self-created term according to a trained machine learning model.

In some embodiments, the trained machine learning model may be obtained by a training process, wherein the training process includes: obtaining a plurality of training samples; extracting a plurality of features of each of the plurality of training samples; and generating the trained machine learning model by training a preliminary machine learning model based on the plurality of features.

In another aspect of the present disclosure, a system for extracting one or more self-created terms in a professional area is provided. The system may include an extraction module, a determination module, and a training module. The extraction module may be configured to extract one or more candidate terms from a text. The determination module may be configured to: determine first data representing an occurrence of each of the one or more candidate terms in the text; determine one or more lemmas of the each of the one or more candidate terms; determine second data representing an occurrence of each of the one or more lemmas in a general corpus; determine third data representing an occurrence of each of the one or more lemmas in a professional area corpus; and determine, based on reference data, a possibility that the each of the one or more candidate terms is a self-created term, wherein the reference data includes the first data, the second data, and the third data.

In some embodiments, the extraction module may be further configured to obtain a plurality of segmented word combinations by performing word segmentation on the text; remove, from the plurality of segmented word combinations, one or more segmented word combinations present in the professional area corpus; and determine the one or more candidate terms from the removed segmented word combinations.

In some embodiments, the reference data further may include a word-class structure.

In some embodiments, the first data may include a first frequency, wherein the first frequency includes at least one of a frequency of the each of the one or more candidate terms in different portions of the text and a frequency of the each of the one or more candidate terms in the text.

In some embodiments, the first data may further include a count of the each of the one or more candidate terms in different portions of the text and/or a count of the each of the one or more candidate terms in the text.

In some embodiments, the determination module may be further configured to: determine the possibility that the each of the one or more candidate terms is the self-created term according to a rule.

In some embodiments, the second data may include a second frequency of each of the one or more lemmas in the general corpus, and the third data includes a third frequency of each of the one or more lemmas in the professional field corpus. The rule includes that: the first frequency exceeds a first threshold; the second frequency is less than a second threshold; and a ratio of the third frequency to the second frequency exceeds a third threshold.

In some embodiments, the rule may further include that a matching degree of the word-class structure of the each of the one or more candidate terms with a preset word-class structure exceeds a fourth threshold.

In some embodiments, the determination module may be further configured to: determine the possibility that the each of the one or more candidate terms is the self-created term according to a trained machine learning model.

In some embodiments, the trained machine learning model may be obtained by a training process conducted by the training module, wherein the training process includes obtaining a plurality of training samples; extracting a plurality of features of each of the plurality of training samples; and generating the trained machine learning model by training a preliminary machine learning model based on the plurality of features.

In another aspect of the present disclosure, a system for extracting a self-created term in a professional area is provided. The system may include at least one storage medium and at least one processor. The at least one storage medium may be configured to store computer instructions. The at least one processor may be configured to execute the computer instructions to implement the method for extracting a self-created term in a professional area.

In another aspect of the present disclosure, a computer-readable storage medium storing computer instructions is provided. When reading computer instructions in the computer-readable storage medium, a computer may execute the method for extracting a self-created term in a professional area.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary system for extracting self-created terms in a professional area according to some embodiments of the present disclosure;

FIG. 2 is a block diagram illustrating the exemplary system for extracting self-created terms in a professional area according to some embodiments of the present disclosure;

FIG. 3 is a flowchart illustrating an exemplary process for determining a possibility that a candidate term is a self-created term according to some embodiments of the present disclosure;

FIG. 4 is a flowchart illustrating an exemplary process for training a machine learning model according to some embodiments of the present disclosure

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular exemplary embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of portions and economies of manufacture, may become more apparent upon consideration of the following description with reference to the accompanying drawings, all of which form a portion of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

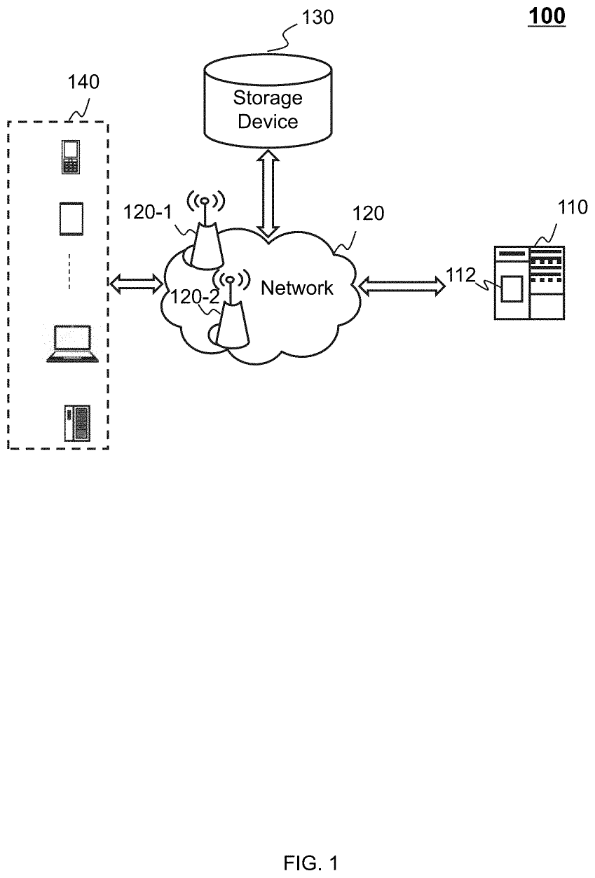

FIG. 1 is a schematic diagram illustrating an exemplary system for extracting self-created terms in a professional area according to some embodiments of the present disclosure.

In some embodiments, a system 100 for extracting self-created terms in a professional area (also referred to as system 100 in brief) may be used to determine a possibility that each of terms is a self-created term from texts in different professional areas. In some embodiments, the system 100 may be used to extract self-created terms from texts in different professional areas. The system 100 may be applied to machine translation, automatic classification and extraction of terms, term labeling, term translation, termbase construction, corpus construction, text classification, text construction, text mining, semantic analysis, or the like, or any combination thereof. In some embodiments, the system 100 may be an online system with a computing capability. For example, the system 100 may be a web-based system. As another example, the system 100 may be an application-based system.

As shown in FIG. 1, the system 100 may include at least one computing device 110, a network 120, a storage device 130, and/or a terminal device 140.

The computing device 110 may include various computers, such as a server, a desktop computer, a laptop computer, a mobile device, or the like, or any combination thereof. In some embodiments, the system 100 may include multiple computing devices that may be connected in various forms (e.g., via the network 120) to form a computing platform.

The computing device 100 may include a processing device 112 that processes information and/or data related to the system 100 to perform the functions of the present disclosure. For example, the processing device 112 may extract candidate terms from a text. As another example, the processing device 112 may determine a possibility that each of the candidate terms is a self-created term from the candidate terms. In some embodiments, the processing device 112 may include one or more processing devices (e.g., a single-core processing device or a multi-core processor). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may connect one or more components of the system 100 (e.g., the computing device 110, the storage device 130, the terminal device 140) so that the components may communicate with each other. The network 120 may be any type of wired or wireless network, or combination thereof. Merely by way of example, the network 120 may include a cable network, a wireline network, an optical fiber network, a telecommunications network, an intranet, an internet, a local area network (LAN), a wide area network (WAN), a wireless local area network (WLAN), a metropolitan area network (MAN), a wide area network (WAN), a public telephone switched network (PTSN), a Bluetooth network, a ZigBee network, a near field communication (NFC) network, or the like, or any combination thereof. In some embodiments, the network 120 may include at least one network access point. For example, the network 120 may include wired network access points or wireless network access points, such as base stations and/or Internet exchange points 120-1, 120-2, . . . , via which one or more components of the system 100 (e.g., the computing device 110, the storage device 130, the terminal device 140) may be connected to the network 120 to exchange data and/or information.

The storage device 130 may store data and/or instructions. In some embodiments, the storage device 130 may store data obtained from the computing device 110 (e.g., the processing device 112). In some embodiments, the storage device 130 may include a large-capacity storage, a removable storage, a volatile read-write memory, a read-only memory (ROM), or the like, or any combination thereof. Exemplary mass storage devices may include magnetic disks, optical disks, solid-state drives, or the like. Exemplary removable storage devices may include flash drives, floppy disks, optical disks, memory cards, magnetic disks, magnetic tapes, or the like. An exemplary volatile read-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM). Exemplary ROM may include a mask ROM (MROM), a programmable ROM (PROM), an erasable programmable ROM (EPROM), an electrically erasable programmable ROM (EEPROM), and a compact disk ROM (CD-ROM). In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the storage device 130 may be part of the computing device 110.

The system 100 may also include a terminal device 140. The terminal device 140 may include a terminal device for information receiving and/or information transmitting functions. The terminal device 140 may include a computer, a mobile device, a text scanning device, a display device, a printer, or the like, or any combination thereof.

In some embodiments, the system 100 may obtain a text to be processed from the storage device 130 or through the network 120. The processing device 112 may execute instructions of the system 100. For example, the processing device 112 may determine candidate terms from the text to be processed. As another example, the processing device 112 may determine a possibility that each of the candidate terms is a self-created term. The result of determining the possibility may be output and displayed through the terminal device 140, stored in the storage device 130, and/or directly executed by the processing device 112 for application (for example, machine translation of a self-created term).

In the system 100, the program instructions and/or data used may be generated through other processes, such as a training process of a machine learning model. The training process may be performed in the system 100, or other systems. The instructions and/or data of the training process performed in other systems may be migrated to the system 100. For example, a machine learning model for determining the possibility that a candidate term is a self-created term may be trained in another processing device, and then migrated to the processing device 112.

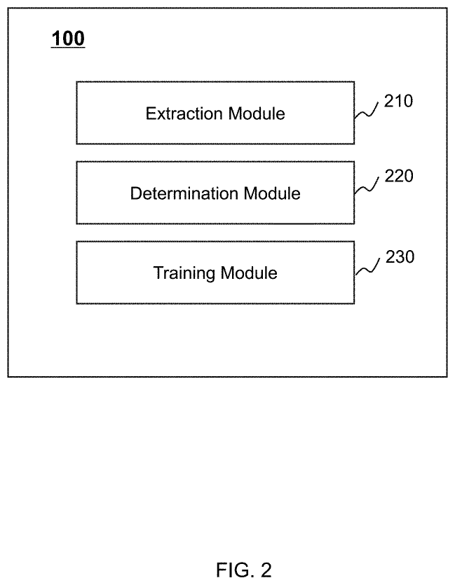

FIG. 2 is a block diagram illustrating the exemplary system for extracting self-created terms in a professional area according to some embodiments of the present disclosure.

As shown in FIG. 2, the system 100 may include an extraction module 210, a determination module 220, and a training module 230.

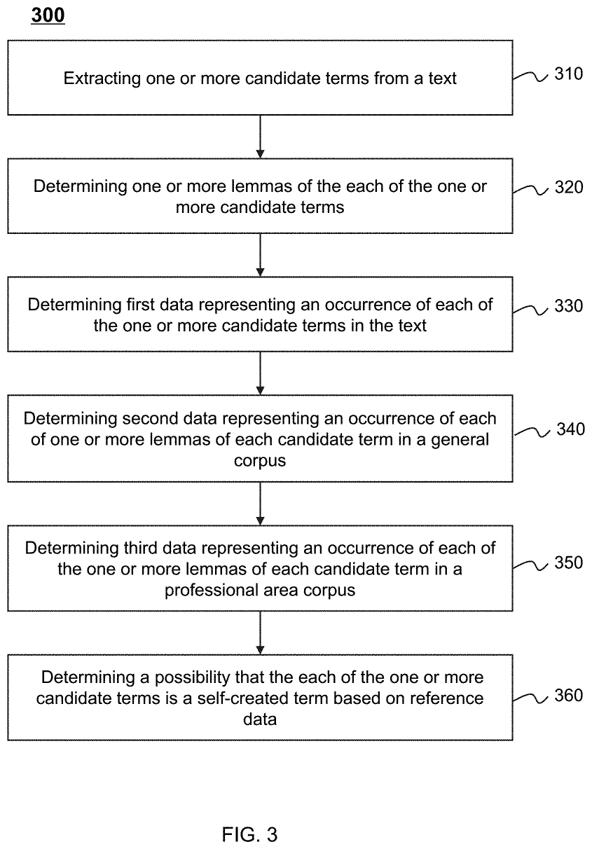

The extraction module 210 may be configured to extract one or more candidate terms from a text. The text may be a text in any professional areas. In some embodiments, the extraction module 210 may obtain a plurality of segmented word combinations by performing word segmentation on the text. The extraction module 210 may remove one or more segmented word combinations present in the professional area corpus from the plurality of segmented word combinations. The extraction module 210 may determine the one or more candidate terms from the removed segmented word combinations. More description about the extraction module 210 may refer to operation 310 in FIG. 3 and descriptions thereof.

The determination module 220 may be configured to determine one or more lemmas of the each of the one or more candidate terms, for example, by lemmatization. In some embodiments, the determination module 220 may determine first data representing an occurrence of each of the one or more candidate terms in the text. The first data may include a first frequency, wherein the first frequency includes at least one of a frequency of the each of the one or more candidate terms in different portions of the text and a frequency of the each of the one or more candidate terms in the text. The first data may further include a count of the each of the one or more candidate terms in different portions of the text and/or a count of the each of the one or more candidate terms in the text. In some embodiments, the determination module 220 may determine second data representing an occurrence of each of the one or more lemmas in a general corpus. In some embodiments, the determination module 220 may determine third data representing an occurrence of each of the one or more lemmas in a professional area corpus. In some embodiments, the determination module 220 may determine, based on reference data (e.g., the first data, the second data, the third data, the word-class structure), a possibility that the each of the one or more candidate terms is a self-created term, wherein the reference data includes the first data, the second data, and the third data. For example, the determination module 220 may determine, based on reference data, a possibility that the each of the one or more candidate terms is a self-created term according to a rule. As another example, the determination module 220 may determine, based on reference data, a possibility that the each of the one or more candidate terms is a self-created term according to a trained machine learning module. More description about the determination module 220 may refer to operations 320 to 360 in FIG. 3 and descriptions thereof.

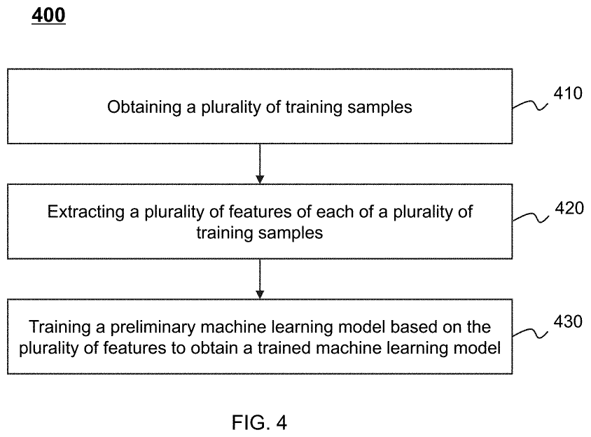

The training module 230 may be configured to train a machine learning module. The machine learning module may be a supervised learning model, for example, a classification model. In some embodiments, the training module 230 may obtain a plurality of training samples. The training module 230 may extract a plurality of features of each of a plurality of training samples. The training module 230 may train a preliminary machine learning model based on the plurality of features to obtain a trained machine learning model. More description about the training module 230 may refer to FIG. 4 and descriptions thereof.

It should be understood that the system and its modules shown in FIG. 2 may be implemented in various ways. For example, in some embodiments, the system and its modules may be implemented by hardware, software, or a combination of software and hardware. The hardware part may be implemented with dedicated logic. The software may be stored in a storage medium and executed by an appropriate instruction.

It should be noted that the above description of the system 100 and its modules is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, any module mentioned above may be divided into two or more units. In some embodiments, one or more the above-mentioned modules may be omitted. For example, the training module 230 may be omitted. A machine learning module may be trained offline or in other systems and then applied in the system 100.

FIG. 3 is a flowchart illustrating an exemplary process for determining a possibility that a candidate term is a self-created term according to some embodiments of the present disclosure. In some embodiments, process 300 may be implemented by the processing device (or the processing device 112). The processing device herein may refer to the processing device 112 shown in FIG. 1. The process 300 may include the following operations.

In step 310, the processing device 112 (e.g., the extraction module 210) may extract one or more candidate terms from a text.

The text may be a text in any professional areas. The professional area may include a professional area of, for example, electronics, communication, artificial intelligence, catering, foreign food, chicken cooking, finance, bonds, US bonds, or the like, or any combination thereof. The present disclosure does not limit the scope of professional areas. The format of the text may include, but not limited to, doc, docx, pdf, txt, xlsx, etc. The text may include a sentence, a paragraph, multiple paragraphs, one or more articles, or the like. The text may include a patent text, a paper text, or the like. In some embodiments, the text may include any single language (e.g., Chinese, English, Japanese, Korean, etc.), official languages and local languages of the same language (e.g., simplified Chinese, traditional Chinese), languages of different countries of the same language (e.g., British English and American English, etc.), etc., or a combination of the various languages (e.g., mixture of Chinese and English).

In some embodiments, the processing device 112 may obtain the text in various ways. For example, the processing device 112 may obtain the text input by a user. The user may input the text through, for example, keyboard input, handwriting input, voice input, etc. As another example, the processing device 112 may obtain the text by importing a file. As a further example, the processing device 112 may obtain the text through an application program interface (API). For example, the text may be directly read from a storage region of a device or a network (e.g., the network 120).

A term (also known as a technical term, a technical term, a scientific term, a scientific and technological term) refers to a word reference or phrase reference that represents a concept in a specific professional area. A term may represent a concept or an entity. A term may include one or more words or phrases.

A candidate term refers to a term extracted from the text that may become a self-created term. A self-created term refers to a term created by a user (for example, a person in a professional area) that may not have appeared or not been commonly used in the professional area. In some embodiments, the candidate term does not include a term that has appeared or has commonly used in the field of the professional area. In some embodiments, the candidate term may be similar to an existing term. For example, the existing term may be a “fixed structure,” and a candidate term may be a “slot structure,” “connection structure,” or the like.

In some embodiments, the processing device 112 may perform segmentation on the text to obtain one or more sentences. For example, the processing device 112 may perform sentence segmentation on the text based on punctuation (e.g., a full stop, a semicolon, etc.) to obtain one or more sentences. In some embodiments, the processing device 112 may perform word segmentation on the sentences to determine characters or words of the sentences. For example, for a Chinese text, Chinese character(s) or Chinese word(s) may be obtained after word segmentation. For an English text, English word(s) may be obtained after word segmentation.

In some embodiments, the processing device 112 may perform different word segmentation processes on different language texts. Taking an English text as an example, the processing device 112 may segment English sentences into English words based on spaces. For example, an English sentence of “a fixed sign identification structure of a vehicle includes a fixed device” may be segmented to obtain English words including “a,” “fixed,” “sign,” “identification,” “structure,” “of,” “a,” “vehicle,” “includes,” “a,” “fixed,” and “device.” In some embodiments, one or more stop words may be removed from the English text. Exemplary stop words may include “a,” “an,” “the,” “of,” “or the like,” etc. For example, after removing the stop words, the above sentence may include English words of “fixed,” “sign,” “identification,” “structure,” “vehicle,” “includes,” “fixed,” and “device.” As another example, an English sentence of “the user of the vehicle cannot determine the type of the vehicle” may be segmented to obtain English words including “the,” “user,” “of,” “the,” “vehicle” “cannot,” “determine,” “the,” “type,” “of,” “the” and “vehicle,” wherein “cannot” (or can't) may be determined as one word.

Taking a Chinese text as an example, the processing device may perform a word segmentation process on the Chinese text by a word segmentation algorithm. Exemplary word segmentation algorithms may include an N-shortest path algorithm, an N-gram model-based algorithm, a neural network segmentation algorithm, a conditional random field (CRF) segmentation algorithm, etc. or any combination thereof (for example, a combination of a neural network segmentation algorithm and a CRF segmentation algorithm). Taking word segmentation on “a fixed sign identification structure of a vehicle includes a fixed device” as an example, the word segmentation result may be “vehicle”, “of”, “fixed”, “sign”, “identification”, “structure”, “includes”, “fixed” and “device”. In some embodiments, the processing device may remove stop words in the sentence to obtain “fixed”, “sign”, “identification”, “structure”, “includes”, “fixed”, and “device”.

In some embodiments, the processing device may determine a plurality of segmented word combinations according to a word segmentation result of the text. A segmented word combination refers to a characters or word or a combination of several consecutive characters or words. For example, a segmented word combination may correspond to a segmented character or word and/or two or more segmented characters or words. In some embodiments, the segmented word combinations may be obtained within a certain length limit according to the word segmentation result. For example, length thresholds may be set for segmented word combinations corresponding to different languages. In some embodiments, the length threshold may be a maximum count of a word length, a maximum count of a character length, or the like. Merely by way of example, the maximum count of a word length may be 4, 5, 6, 7, 8, 9, 10, etc. The maximum count of the character length may be 6, 7, 8, 9, 10, 11, 12, etc. The length threshold may be related to a length of an existing technical term. The processing device may determine the segmented word combinations based on the length threshold and the word segmentation result of the text. For example, if a word segmentation result of a Chinese sentence is “vehicle”, “fixed”, “sign”, “identification”, “structure”, “includes”, “fixed”, and “device”, and the length threshold is 8 characters, the processing device may determine that the segmented word combination may include “vehicle”, “fixed”, “sign”, “identification”, “structure”, “includes”, “fixed”, “device”, “vehicle fixed”, “fixed sign”, “sign identification”, “structure includes”, “includes fixed”, “fixed device”, “vehicle fixed sign”, “fixed sign identification”, “sign identification structure”, “identification structure includes”, “structure includes fixed”, “includes fixed device”, “vehicle fixed sign identification”, “fixed sign identification structure”, “sign identification structure includes”, “identification structure includes fixed”, “structure includes fixed device”. As another example, if a word segmentation result of an English sentence is “fixed”, “sign”, “identification”, “structure”, “vehicle”, “includes”, “fixed”, “device”, and the length threshold is 4 words, the processing device may determine that the segmented word combination includes “fixed”, “sign”, “identification”, “structure”, “vehicle”, “includes”, “fixed”, “device”, “fixed sign”, “sign identification”, “identification structure”, “structure vehicle”, “vehicle includes”, “includes fixed”, “fixed device”, “fixed sign identification”, “sign identification structure”, “identification structure vehicle”, “structure vehicle includes”, “vehicle includes fixed”, “includes fixed device”, “fixed sign identification structure”, “sign identification structure vehicle”, “identification structure vehicle includes”, “structure vehicle includes fixed”, and “vehicle includes fixed device”.

In some embodiments, the processing device may perform lemmatization on the segmented word combinations for languages (e.g., English) that allow lemmatization. The lemmatization refers to a process of returning transformation forms (e.g., plural form, past tense form, past participle form) of a word (e.g., an English word) to a base form of the word (i.e., a dictionary form of the word). For example, the processing device may return “includes”, “including”, “included” to the base form of “include.” As another example, the processing device may return “doing,” “done,” “did,” and “does” to the basic form of “do.” Merely by way of example, the processing device may perform lemmatization on “fixed sign” to obtain “fix sign”.

In some embodiments, the processing device may perform lemmatization on the segmented word combinations based on a dictionary. For example, the segmented word combinations may be matched with words in a dictionary, and base form(s) of the segmented word combinations may be determined by a matching result. In some embodiments, the processing device may perform lemmatization on the segmented word combination based on based on rule-based algorithms. The rule may be written manually or may be learned automatically from annotated corpus. For example, lemmatization may be performed by using an if-then rule algorithm, a ripple down rules (RDR) induction algorithm, or the like.

In some embodiments, the processing device may perform word-class tagging on the segmented word combinations to determine word-class structures of the segmented word combinations. For example, the processing device may perform word-class tagging on the segmented word combinations by using a word-class tagging algorithm. Exemplary word-class tagging algorithms may include a word-class tagging algorithm based on maximum entropy, a word-class algorithm based on statistical maximum probability output, a word-class tagging algorithm based on Hidden Markov Model (HMM), or a word-class tagging algorithm based on CRF, or the like, or any combination thereof. For example, a word-class structure of segmented word combinations of “identification structure,” “sign identification” may be “noun+noun”. As another example, a word-class structure of a segmented word combination of “vehicle includes” may be “noun+verb”. As a further example, a word-class structure of a segmented word combination of “sign identification structure” may be “noun+noun+noun”, and a word-class structure of a segmented word combination of “fixed sign identification structure” may be “adjective+noun+noun+noun”.

In some embodiments, the word segmentation processing and the word-class tagging processing may be performed by the same algorithm, for example, using the jieba word segmentation algorithm. In some embodiments, the word segmentation processing and the word-class tagging processing may be performed by different algorithms. For example, the word segmentation processing is performed by the N-shortest path algorithm, and the word-class tagging is performed by the word-class tagging algorithm based on Hidden Markov Model (HMM). In some embodiments, the word segmentation processing and the word-class tagging processing may be completed at the same time, or not. For example, the word segmentation processing may be completed first and then word-class tagging may be completed, or the word-class tagging processing may be completed first and then the word segmentation processing may be completed.

In some embodiments, the processing device may remove one or more segmented word combinations present in a professional area corpus from the segmented word combinations.

The professional area corpus refers to a corpus including specialized texts used by people (e.g., professionals) in a professional area. In some embodiments, the professional area corpus may be a corpus including terms in the professional area. For example, the professional area corpus may include professional terms. An area of the professional area corpus may be at least the same as or include an area of the text to be processed. Merely by way of example, if the text to be processed belongs to an area of a machine learning model, the professional area corpus may belong to the area of the machine learning model or the computer.

In some embodiments, segmented word combinations of the professional area corpus may be obtained from a professional dictionary, Wikipedia, etc., or obtained by users in other ways. The segmented word combinations of the professional area corpus may be stored in the computing device (e.g., the storage device 130) in advance.

In some embodiments, the processing device may determine a professional area of the text. In some embodiments, the processing device may classify the text by a classification algorithm, and determine the professional area to which the text belongs according to the classification result. For example, the processing device may classify the text based on the statistical feature of the text in combination with a classifier. As another example, the processing device may classify the text by a BERT model in combination with a classifier. In some embodiments, the processing device may determine a professional area of the text according to the content of the text. For example, the processing device may determine a professional area of a patent application based on the content of the technical field of the patent application.

In some embodiments, the processing device may compare the professional area corpus to which the text belongs with the segmented word combinations of the text, so as to remove the segmented word combination(s) present in the professional area corpus from the segmented word combinations. The processing device may determine candidate term(s) from the removed segmented word combinations. In some embodiments, the processing device may determine all the removed segmented word combinations as candidate terms. In some embodiments, the processing device may determine all the removed segmented word combinations that are marked as nouns as candidate terms. In some embodiments, the processing device may determine at least one noun of the removed segmented word combinations as a candidate term.

In some embodiments, the processing device may determine segmented word combination(s) with a word length or a character length less than a threshold in the segmented word combinations as candidate term(s). For example, a character length of a candidate term “fixed sign” is 4 and a word length of the candidate term “sign identification” is 2. In some embodiments, the threshold may be less than 20. For example, the threshold may be in the range of 2-10.

In some embodiments, the processing device may rank word spans of the segmented word combinations (e.g., in a reverse order), and determine the word segmentation combinations that are in a relatively high rank (e.g., top 30%) as candidate terms. In some embodiments, the processing device may determine the word segmentation combinations whose word spans exceed a threshold (e.g., an average value of all word spans) as candidate terms. A word span refers to a distance between the first and last occurrence of a segmented word combination in the text. The word span may indicate the importance of the candidate term in the text. The larger the word span is, the more important the candidate term is to the text. The calculation equation for the word span is as follows:

$$spa {n}_{i} = \frac{las {t}_{i} - {first}_{i} + 1}{sum}$$

wherein lastᵢ represents a last position where a candidate term represented by I appears in the text, firstᵢ represents a first position where the candidate term represented by a appears in the text, and sum represents the total count of words or characters in the text.

In some embodiments, the process for determining candidate terms may be a combination of the above processed, and the present disclosure is not limited herein. Merely by wat of example, the candidate terms from the above segmented word combinations in Chinese may include “vehicle”, “sign”, “structure”, “device”, “fixed sign”, “fixed device”, “fixed sign of the vehicle”, “sign identification structure”, “fixed sign identification structure”, and the candidate terms from the above segmented word combinations in English may include “sign”, “identification”, “structure”, “vehicle”, “fixed”, “device”, “fixed sign”, “sign identification”, “identification structure”, “structure vehicle”, “fixed device”, “fixed sign identification”, “sign identification structure”, “identification structure vehicle”, “includes fixed device”, “fixed sign identification structure”, “sign identification structure vehicle”, and “vehicle includes fixed device”.

In step 320, the processing device (e.g., the determination module 220) may determine one or more lemmas of the each of the one or more candidate terms.

A lemma refers to the smallest unit in a candidate term, which is the word segmentation result in operation 310. Taking a Chinese candidate term as an example, a lemma refers to a character or a word that constitutes the Chinese candidate term. For example, “fixed” and “device” are lemmas of a candidate word of “fixed device”. Taking an English candidate term as an example, a lemma refers to a word that constitutes the English candidate term. For example, “identification” and “structure” are lemmas of “identification structure.” In some embodiments, the processing device may determine a base form of a lemma (i.e., a dictionary form). For example, the processing device may determine the base form of the lemma by means of lemmatization. More detailed descriptions about the lemmatization can be found in the description of operation 310.

In step 330, the processing device (e.g., the determination module 220) may determine first data representing an occurrence of each of the one or more candidate terms in the text.

As used herein, “an occurrence of a candidate term (or lemma) in the text (or the general corpus, the professional area corpus)” means that the text (or the general corpus, the professional area corpus) includes the candidate term (or the lemma). For example, “the occurrence of each candidate term in the text” means that the text includes each candidate term.

In some embodiments, multiple similar wordings (such as, fourth and forth) of a candidate term may be considered as the same candidate term. In some embodiments, different forms of a candidate term may be considered as the same candidate term. Taking an English text as an example, two candidate terms, part or whole of which has different forms, may be regarded as the same candidate term. For example, “fixed device” and “fix device” may be regarded as the same candidate term.

In some embodiments, the first data representing the occurrence of each of the one or more candidate terms in the text may include a first count, a first frequency, or the like, or any combination thereof.

In some embodiments, the first count may include a count of each candidate term present in the entire text (also referred to as a first total count), a count of each candidate term present in different portions of the text (also referred to as a first sub-count), or the like, or any combination thereof. A count of a candidate term in the entire text or in different portions of the text reflects the importance of the candidate term in the entire text or in different portions of the text. For example, the more a candidate term is present in a text, the more important the term is in the text. In some embodiments, the text may include different portions. For example, a text may be a patent literature, and the patent literature may include a description, an abstract, and a claim. The description may include the title, the background, the summary, the description of the drawings, and detailed description. As another example, the text may be a scientific paper, and the scientific paper may include the title, the abstract, and the main text. The candidate terms may have different importance in different portions of the text.

In some embodiments, the processing device may match the candidate terms with the content of the text, and determine the count of each candidate term in the entire text in a statistical manner. In some embodiments, the processing device may identify markers (e.g., titles) that can distinguish different portions. The processing device may then determine the first sub-count in the corresponding portions of the text based on the markers. Taking determination of the candidate terms in the claim of an English patent as an example, the processing device may recognize the title “claim” and the title “abstract” after the claim, determine the content between the two titles as the claim, and thus determine the count of each candidate term in the claim.

In some embodiments, the first frequency may include a frequency of each candidate term in the entire text (also referred to as the first total frequency), and a frequency of each candidate term in different portions of the text (also referred to as first sub-frequency), or the like, or any combination thereof.

The first total frequency of a candidate term refers to a ratio of the count of the candidate term in the text to the sum of the count of all words and/or characters in the text after word segmentation.

In some embodiments, the processing device may determine the first total frequency of each candidate term by dividing the count of each candidate term in the text by the count of all words and/or words in the text after word segmentation. Merely by way of example, if a count of a candidate term (e.g., fixed sign identification structure) in a patent literature is 10, and the patent literature has 100 words (and/or characters) after the word segmentation, the frequency of the candidate term in the patent literature is 0.1 (i.e., 10/100=0.1), that is, the first total frequency of the candidate term is 0.1.

The first sub-frequency of a candidate term refers to a ratio of the count of the candidate term in a certain portion (e.g., description, claim, abstract of a patent) of the text to the sum of the total counts of words and/or characters in the text after the word segmentation (or the sum of the counts of words and/or characters in the corresponding portions of the text after the word segmentation).

In some embodiments, the processing device may divide the count of each candidate term in a portion of the text by the counts of all words and/or characters in the text after word segmentation (or the counts of all words and/or characters in the portion) to determine a first sub-frequency of each candidate term in the portions of the text. Merely by way of example, if a count of a candidate term (e.g., fixed sign identification structure) in the claim of a patent literature is 5, and a count of the candidate term in the abstract of the patent literature is 2, there are 100 words (and/or characters) in the text after the word segmentation, then the frequency of this candidate term in the claim is 0.05 (i.e., 5/100=0.05) and the frequency of the candidate term in the abstract is 0.02 (i.e., 2/100=0.02). That is, the first sub-frequency of this candidate term in the claim of the patent literatures is 0.05, and the first sub-frequency of the candidate term in the abstract is 0.02.

In step 340, the processing device (e.g., the determination module 220) may determine second data representing an occurrence of each of one or more lemmas of each candidate term in a general corpus.

The general corpus refers to a corpus including texts that are not specifically used in a certain area, that is, a corpus including texts in a plurality of areas. The general corpus may be a corpus including general terms, sentences, paragraphs, or articles. In some embodiments, the general corpus may include a general Chinese corpus, Academia Sinica Tagged Corpus of Early Mandarin Chinese, Linguistic Variation in Chinese Speech Communities, a Corpus of Contemporary American English (COCA), a Brigham Young University corpus, a British National Corpus, etc., or a combination thereof.

In some embodiments, the general corpus may be prepared in advance and stored in a storage device (e.g., the storage device 130). The processing device may access the storage device 130 (e.g., the storage device 130) via the network 120 to obtain the general corpus.

In some embodiments, the second data representing the occurrence of each of the one or more lemmas of each candidate term in the general corpus may include a count of each of the lemma(s) of each candidate term in the general corpus (also referred to as a second count), a frequency of each of the lemma(s) of each candidate term in the general corpus (also referred to as a second frequency), or the like, or any combination thereof.

The frequency (i.e., the second frequency) of each of lemma(s) of a candidate term in the general corpus refers to a ratio of a count of each of the lemma(s) of the candidate term in a portion of the general corpus to the sum of a count of words (and/or characters) in the portion of the general corpus. In some embodiments, the portion may be remaining words (and/or characters) after removing stop words, meaningless symbols (for example, an equation symbol), etc., from the general corpus. In some embodiments, the portion may be per thousand words (and/or characters) of the general corpus. For example, the frequency of each of lemma(s) of each candidate term in the general corpus is a ratio of a count of each of lemma(s) of each candidate term in per thousand words (and/or characters) of the general corpus to one thousand.

In some embodiments, the processing device may match the lemma(s) of each candidate term with the contents in the general corpus, and determine the second data representing the occurrence of each of the one or more lemmas of each candidate term in the general corpus in a statistical manner. In some embodiments, the processing device may divide the count of each of the lemma(s) of the candidate term in the portion of the general corpus to the sum of the count of words (and/or characters) in the portion of the general corpus (for example, per thousand words/characters) to determine the second frequency of each of the lemma(s) of the candidate term. Merely by way of example, if a count of a lemma (e.g., structure) of a candidate term (e.g., fixed sign identification structure) in a thousand-word portion of the general corpus is 20, a second frequency of the lemma of the candidate term in the general corpus is 0.02 (i.e., 20/1000=0.02).

In step 350, the processing device (e.g., the determination module 220) may determine third data representing an occurrence of each of the one or more lemmas of each candidate term in a professional area corpus.

In some embodiments, the third data representing the occurrence of each of the one or more lemmas of each candidate term in the professional area corpus may include a count of each of the lemma(s) of each candidate term in the professional area corpus (also referred to as a third count), a frequency of each of the lemma(s) of each candidate term in the professional area corpus (also referred to as a third frequency), or the like, or any combination thereof.

The frequency (i.e., the third frequency) of each of the lemma(s) of a candidate term in the professional area corpus refers to a ratio of a count of each of the lemma(s) of the candidate term in a portion of the professional area corpus to the sum of a count of words (and/or characters) in the portion of the professional area corpus. In some embodiments, the portion may be remaining words (and/or characters) after removing stop words, meaningless symbols (for example, an equation symbol), etc., from the professional area corpus. In some embodiments, the portion may be per thousand words (and/or characters) of the professional area corpus. For example, the frequency of each of lemma(s) of each candidate term in the professional area corpus is a ratio of a count of each of lemma(s) of each candidate term in per thousand words (and/or characters) of the professional area corpus to one thousand.

In some embodiments, the processing device may match the lemma(s) of each candidate term with the contents in the professional area corpus, and determine the third data representing the occurrence of each of the one or more lemmas of each candidate term in the professional area corpus in a statistical manner. In some embodiments, the processing device may divide the count of each of the lemma(s) of the candidate term in the portion of the professional area corpus to the sum of the count of words (and/or characters) in the portion of the professional area corpus (for example, per thousand words/characters) to determine the third frequency of each of the lemma(s) of the candidate term. Merely by way of example, if a count of a lemma (e.g., structure) of a candidate term (e.g., fixed sign identification structure) in a thousand-word portion of the professional area corpus is 10, a third frequency of the lemma of the candidate term in the professional area corpus is 0.01 (i.e., 50/100=0.05).

In step 360, the processing device (e.g., the determination module 220) may determine a possibility that the each of the one or more candidate terms is a self-created term based on reference data.

In some embodiments, the reference data may include the first data, the second data, the third data, or the like, or any combination thereof. In some embodiments, the reference data may further include a word-class structure of each candidate term. In some embodiments, a word-class structure of a candidate term may be the same as a word-class structure of a term already in the professional area corpus. Therefore, it is helpful to better determine whether each candidate term is a self-created term by determining the word-class structure of each candidate term.

In some embodiments, the processing device may determine the possibility that each candidate term is a self-created term according to a rule based on the reference data. In some embodiments, the rule may be a system default or may vary according to different situations. In some embodiments, the rule may be manually set by a user or determined by one or more components (e.g., the processing device 112) of the system 100.

In some embodiments, the rule may include that the first frequency exceeds a first threshold (also referred to as a first rule), the second frequency is less than a second threshold (also known as a second rule), a ratio of the third frequency to the second frequency exceeds a third threshold (also known as a third rule), or the like, or any combination thereof. A result that a candidate term satisfies the first rule may indicate that a candidate term is a high-frequency term in the text and is of high importance. A result that lemma(s) of a candidate term satisfies the second rule and the third rule may indicate a frequency of each of the lemma(s) of the candidate term in the general corpus is relatively low, and a frequency of each of the lemma(s) of the candidate term present in the professional area corpus is higher than that in the general corpus.

In some embodiments, the first rule may include that the first total frequency of the candidate term exceeds the first threshold, the first sub-frequency of the candidate term exceeds the first threshold, or the like, or any combination thereof. For example, a first totol frequency of “fixed sign identification structure” exceeds the first threshold. In some embodiments, the second rule may include the second frequency of each of the lemma(s) of each candidate term is less than the second threshold, the second frequency of part of the lemma(s) of each candidate term (for example, ½, ⅔ of a total count of all lemmas of the candidate term) is less than the second threshold, the product of the second frequency of each of the lemma(s) of the candidate term and the second threshold is less than the second threshold, or the like. For example, a second frequency of each lemma of “fixed sign identification structure” is less than the second threshold. In some embodiments, the third rule may include that the ratio of the third frequency to the second frequency of each of the lemma(s) of the candidate term exceeds the third threshold, the ratio of the third frequency to the second frequency of part of the lemma(s) of the candidate term (for example, ½, ⅔ of the total count of all lemmas of the candidate term) exceeds the third threshold, or the like. For example, a ratio of a third frequency to the second frequency of each lemma of “fixed sign identification structure” exceeds the third threshold.

In some embodiments, the rule may also include that a matching degree of the word-class structure of each of the one or more candidate terms with a preset word-class structure exceeds a fourth threshold (also referred to as a fourth rule). As described in the present disclosure, the “preset word-class structure” may be one or more word-class structures common in technical terms in a professional area. In some embodiments, the preset word-class structure may be determined by counting word-class structures of technical terms in a professional area. The preset word-class structure may include one or more word-class structures, such as, “noun+noun,” “adjective+noun,” “adjective+noun+noun+noun,” etc. As described herein, “the matching degree of the word-class structure of each candidate term with the preset word-class structure” refers to a similarity between the word-class structure of each candidate term and the preset word-class structure. For example, if the preset word-class structure is “adjective+noun+noun+noun”, a word-class structure of a first candidate term (e.g., sign identification structure) is “noun+noun+noun”, and a word-class structure of a second candidate term (e.g., fixed sign identification structure) is “adjective+noun+noun+noun”, the processing device may determine that a matching degree of the word-class structure of the first candidate term with the preset word-class structure is 75%, and a matching degree of the word-class structure of the second candidate term with the preset word-class structure is 100%.

The first threshold, the second threshold, the third threshold, and the fourth threshold may be system default or adjustable in different situations. In some embodiments, first threshold, the second threshold, the third threshold, and the fourth threshold may be determined in advance. The first threshold may be related to the first frequency of each candidate term in the text. For example, the first threshold may be an average of the first frequencies of all candidate terms in the text. As another example, the first threshold may be a frequency value in a certain ranking (for example, in a middle ranking) by ranking the first frequencies of all candidate terms in the text. In some embodiments, the second threshold may be related to the second frequency of each of the lemma(s) of each candidate term in the general corpus. For example, the second threshold may be an average of the second frequencies of the lemmas of all candidate terms. As another example, the second threshold may be a frequency value in a certain ranking (for example, in a middle ranking) by ranking the second frequencies of the lemmas of all candidate terms. In some embodiments, the third threshold may be related to the second frequency and the third frequency. For example, the third threshold may be a ratio of the average of the third frequencies of all candidate terms to the average of the second frequencies of the lemmas of all candidate terms. In some embodiments, the third threshold may be 1, that is, the third frequency of a lemma of a candidate term exceeds the second frequency of the lemma of the candidate term. That is, a frequency of the lemma of the candidate term in the professional area corpus exceeds that of the lemma of the candidate term in the general corpus. In some embodiments, the fourth threshold may be set to 50%.

In some embodiments, the processing device may determine the possibility that a candidate term is a self-created term according to the rule. The probability that the candidate term is the self-created term (also referred to as a probability of a candidate term in brevity) may reflect the possibility that the candidate term is the self-created term (also referred to as a possibility of a candidate term in brevity). In some embodiments, a higher probability of a candidate term corresponds to a higher possibility that the candidate term is a self-created term. For example, a candidate term with a probability of 0.7 is more likely to be a self-created term compared to a candidate term with a probability of 0.3.

In some embodiments, the probability of the candidate term may be denoted as a number. For example, when a candidate term satisfies all the rules, the probability that the candidate term is a self-created term is 1. Merely by way of example, “fixed sign identification structure” satisfies all the rules, and a probability that “fixed sign identification structure” is a self-created term is 1. As another example, when a candidate term does not satisfy any of the rules, the probability that the candidate term is a self-created term is 0. Merely by way of example, “vehicle” does not satisfy any of the rules, and a probability that “vehicle” is a self-created term is 0. As a further example, when a candidate term satisfies one or more of the rules, the probability that the candidate term is a self-created term is medium or a value between 0-1. In some embodiments, the processing device may determine the possibility that the candidate term is a self-created term according to a possibility corresponding to each rule. For example, if a possibility corresponding to each satisfied rule may be 0.25, and a possibility corresponding to each unsatisfied rule may be 0, the probability that the candidate term is a self-created term may be determined by adding the possibilities corresponding to the satisfied rules. Merely by way of example, “fixed device” satisfies two rules, and a probability that “fixed device” is a self-created term is 0.5. In some embodiments, the processing device may determine the possibility that the candidate term is a self-created term according to the possibility corresponding to each rule and a weight corresponding to each rule. The weight corresponding to each rule may indicate the importance of each rule. For example, a weight corresponding to a first sub-frequency of a candidate term in the claim (or the detailed description) of a patent literature exceeds a weight corresponding to a first sub-frequency of a candidate term in the abstract (or the background, the brief description of the drawings) of the patent literature.

In some embodiments, the possibility of the candidate term may be denoted as a level (e.g., a high level, a medium level, a low level). For example, the processing device may set a range of a first probability threshold corresponding to a high level (for example, 0 to 0.2), a range of a second probability threshold corresponding to a medium level (for example, 0.2 to 0.8), and a range of a third probability threshold corresponding to a low level (for example, 0.8 to 1.0). The processing device may determine the probability level of the candidate term according to the probability of the candidate term and the range of the probability threshold.

In some embodiments, the processing device may determine whether the candidate term is a self-created term based on the probability of the candidate term and a probability threshold. For example, the processing device may determine whether the probability of the candidate term exceeds the probability threshold. If the processing device determines that the probability of the candidate term exceeds the probability threshold, the processing device may determine that the candidate term is a self-created term and extract the self-created term for further analysis (e.g., translation). If the processing device determines that the probability of the candidate term does not exceed the probability threshold, the processing device may determine that the candidate term is not a self-created term. In some embodiments, the probability threshold may be set by the user (for example, based on user experience) or the default setting of the system 100. For example, when the probability is in the range of 0 to 1, the probability threshold may be set to any value from 0 to 1 (e.g., 0.6, 0.8, 0.9, etc.). Merely by way of example, the probability that “fixed sign identification structure” is a self-created term exceeds the probability threshold (e.g., 0.9), and the processing device may determine “fixed sign identification structure” is a self-created term and extract it. The probability that “fixed device” is a self-created term is less than the probability threshold (e.g., 0.9), and the determine “fixed device” is not a self-created term.

It should be noted that the above description of the rules is only an example, and should not be considered as a limitation on this present disclosure. In some embodiments, the rule may also include that the first count (the first total count and/or the first sub-count) of the candidate term exceeds a fifth threshold, and the second count of each of the lemma(s) of each candidate term is less than a sixth threshold, a ratio of the third count of each of the lemma(s) of each candidate term to the second count of each of the lemma(s) of each candidate term exceeds a seventh threshold, etc., or any combination thereof.

In some embodiments, the processing device may determine the possibility that the candidate term is a self-created term according to a trained machine learning model. For example, the processing device may input the first data (for example, the first count, the first frequency), the second data (e.g., the second count, the second frequency), the third data (e.g., the third count, the third frequency) and the word-class structure of each candidate term into the trained machine learning model. The trained machine learning model may output a probability that the candidate term is a self-created term. In some embodiments, the processing device may train a preliminary machine learning model based on a plurality of training samples to generate a trained machine learning model. In some embodiments, the trained machine learning model may include a supervised learning model. The supervised learning model may include a classification model. More description about training a machine learning model may refer to FIG. 4 and description thereof, which will not be repeated here.

It should be noted that the above description regarding the process 300 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, in some embodiments, two or more operations may be implemented simultaneously, such as, extracting one or more candidate terms from the text and determining the lemma(s) of each candidate term may be implemented simultaneously. In some embodiments, the order of the operations of the process 300 may be changed. For example, operation 330 may be implemented before operation 320. As another example, operation 350 may be implemented before operation 340.

FIG. 4 is a flowchart illustrating an exemplary process for training a machine learning model according to some embodiments of the present disclosure. In some embodiments, process 400 may be implemented by the processing device (or the processing device 112). The processing device herein may refer to the processing device 112 shown in FIG. 1. The process 400 may include the following operations.

In step 410, the processing device (e.g., the training module 230) may obtain a plurality of training samples.

In some embodiments, the training samples may include a plurality of sample terms extracted from each historical text. In some embodiments, the sample terms may be obtained through the process described above, or may be determined through user selection. The historical text may include part (for example, abstract and claim in a patent literature, abstract of a paper, etc.) of the historical text (e.g., patents, papers, etc.), or the entire content of the historical text (e.g., patents, papers, etc.). The historical text may be obtained from a database (for example, a patent literature database, a scientific paper database), a storage device, or obtained through another interface.

In step 420, the processing device (e.g., the training module 230) may extract a plurality of features of each of a plurality of training samples.

In some embodiments, the features may include first data (e.g., a first count, a first frequency), second data (e.g., a second count, a second frequency), third data (e.g., a third count, a third frequency), a word-class structure of each sample term in each training sample, etc., or any combination thereof. The first data, the second data, the third data, and the word-class structure of each sample term may be obtained in the process described in FIG. 3.

In some embodiments, each feature may correspond to a weight. As described herein, the weight of each feature represents the importance when training a preliminary machine learning model. For example, the weight corresponding to the first data of each sample term and the weight corresponding to the third data may be higher, and the weight corresponding to the second data of each sample data may be lower. As another example, a weight corresponding to a first sub-frequency of each of lemma(s) of each sample term in the claim of a patent application (or the detailed description) may be higher than a weight corresponding to a first sub-frequency of each of the lemma(s) of each sample term in the abstract (or background).

In some embodiments, the processing device may determine labels of the training samples. As described in the present disclosure, the labels of the training samples may be related to whether the training samples are self-created terms. For example, if a training sample is a self-created term, a label value of the training sample is 1. If a training sample is not a self-created term, a label value of the training sample is 0. In some embodiments, users of the system 100 may manually determine the label values of the training samples. In some embodiments, the label values of the training samples may be determined by the rules described in FIG. 3.

In some embodiments, the processing device may transform the features to obtain corresponding vector features. For example, the features may be digitized and transformed into vectors in Euclidean space.

In step 430, the processing device may train a preliminary machine learning model based on the plurality of features to obtain a trained machine learning model.

The preliminary machine learning model refers to a machine learning model that needs to be trained. In some embodiments, the preliminary machine learning model may be a supervised machine learning model. For example, the preliminary machine learning model may be a classification model. The classification model may include a logistic regression model, a gradient boosted decision tree (GBDT) model, an extreme gradient boost (XGBoost) model, a random forest model, a decision tree model, a support vector machine (SVM), naive Bayes, etc., or any combination thereof. In some embodiments, the preliminary machine learning model may include a plurality of parameters. Exemplary parameters may include a size of a kernel of a layer, a total count (or number) of layers, a count (or number) of nodes in each layer, a learning rate, a batch size, an epoch, a connected weight between two connected nodes, a bias vector relating to a node, etc. The parameters of the preliminary machine learning model may be default settings, or adjusted by users or one or more components of the system 100 in different situations. Taking the XGBoost model as the preliminary classification model as an example, the preliminary machine learning model may include a booster type (for example, a tree-based model or a linear model), booster parameters (for example, a maximum depth, a maximum number of leaf nodes), learning task parameters (for example, a target function to be trained), or the like, or any combination thereof.

In some embodiments, the preliminary machine learning model may be trained to generate the trained machine learning model (also referred to as a term model). The term model may be configured to determine or predict the probability that a candidate term is a self-created term and/or a category indicating whether a candidate term is a self-created term. For example, the processing device may input the candidate terms and the first frequency, the second frequency, the third frequency, and the word-class structure of each of the candidate terms into the term model, and the term model may output the possibility that the candidate term is the self-created term or whether the candidate term is the self-created term.

In some embodiments, the preliminary machine learning model may be trained using a training algorithm based on a plurality of training samples. Exemplary training algorithms may include a gradient descent algorithm, Newton's algorithm, a Quasi-Newton algorithm, a Levenberg-Marquardt algorithm, a conjugate gradient algorithm, a generative adversarial learning algorithm, or the like.

In some embodiments, one or more parameter values of the preliminary machine learning model may be updated by performing multiple iterations to generate a trained machine learning model. For each iteration of multiple iterations, the features of the training samples and the corresponding label values may be first input into the preliminary machine learning model. For example, features of a sample term may be input into an input layer of the preliminary machine learning model, and a label value corresponding to the sample term may be input into an output layer of the preliminary machine learning model as the expected output of the preliminary machine learning model. The preliminary machine learning model may determine a predicted output (e.g., a predicted probability) of the sample term based on the features of the sample term. The processing device may compare predicted outputs of the training samples with expected outputs of the training samples. The processing device may update one or more parameters of the preliminary machine learning model based on comparison results, and generate an updated machine learning model. The predicted output generated by updating the machine learning model based on the training sample may be closer to the expected output compared to the predicted output generated by the preliminary machine learning model.

Multiple iterations may be performed to update the parameter values of the preliminary machine learning model (or the updated the machine learning model) until a termination condition is met. The termination condition may provide an indication as to whether the preliminary machine learning model (or the updated machine learning model) is sufficiently trained. In some embodiments, the termination condition may be related to the count of iterations that have been performed. For example, the termination condition may be that the count of iterations that have been performed exceeds a count threshold. In some embodiments, the termination condition may be related to the degree of change in the one or more model parameters between successive iterations (e.g., the degree of change in model parameters updated in a current iteration compared to model parameters updated in the previous iteration). For example, the termination condition may be that the degree of change in the one or more model parameters between successive iterations is less than a degree threshold. In some embodiments, the termination condition may be related to a difference between the predicted output (such as the predicted probability) and the expected output (such as the label value). For example, the termination condition may be that the difference between the predicted output and the expected output is less than the difference threshold.

If it is determined that the updated machine learning model satisfies the termination condition, the processing device may determine that the corresponding updated machine learning model obtained in the last iteration has been sufficiently trained. The processing device may determine the updated machine learning model as a trained machine learning model. The trained machine learning model may output the possibility that a candidate term is a self-created term based on the features of the candidate term.

If it is determined that the updated machine learning model is not satisfied the termination condition, the processing device may continue to perform one or more iterations to further update the updated machine learning model until the termination condition is satisfied.

In some embodiments, the updated machine learning models may also be tested with test samples. The test samples may be the same as a portion of the training samples. For example, the obtained samples may be divided into a training set for training the machine learning model and a test set for testing the adjusted machine learning model. Features of each of the test samples may be input into the updated machine learning model to output a corresponding predicted output. The processing device may further determine a difference between the predicted output and an expected output of a test sample. If the difference satisfies a predetermined condition, the processing device may designate the updated machine learning model as the term model. If the difference does not satisfy the predetermined condition, the processing device may further train the updated machine learning model with additional samples until the difference satisfies the predetermined condition to obtain the term model. The predetermined condition may be a default value stored in the system 100 or determined by users and/or the system 100 according to different situations.

In some embodiments, the trained machine learning model may be updated from time to time, e.g., periodically or not, based on a sample set that is at least partially different from an original sample set from which an original trained machine learning model is determined. For instance, the trained machine learning model may be updated based on a sample set including new samples that are not in the original sample set, samples processed using the machine learning model in connection with the original trained machine learning model of a prior version, or the like, or a combination thereof. In some embodiments, the determination and/or updating of the trained machine learning model may be performed on a processing device, while the application of the trained machine learning model may be performed on a different processing device. In some embodiments, the determination and/or updating of the trained machine learning model may be performed on a processing device of a system different than the system 100 or a server different than a server including the processing device on which the application of the trained machine learning model is performed. For instance, the determination and/or updating of the trained machine learning model may be performed on a first system of a vendor who provides and/or maintains such a machine learning model and/or has access to training samples used to determine and/or update the trained machine learning model, while self-created term determination based on the provided machine learning model may be performed on a second system of a client of the vendor. In some embodiments, the determination and/or updating of the trained machine learning model may be performed online in response to a request for self-created term determination. In some embodiments, the determination and/or updating of the trained machine learning model may be performed offline.

It should be noted that the above description regarding the process 400 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

The beneficial effects that the embodiments of the present disclosure bring may include, but not limited to: (1) by determining whether a candidate term is a self-created term based on a rule and/or a machine learning model, the efficiency and accuracy of identifying self-created terms can be improved, and the working amount of artificial recognition can be reduced; (2) by determining self-created terms and distinguishing it from existing professional terms, corpuses can be enriched. It should be noted that different embodiments may have different beneficial effects. In different embodiments, the possible beneficial effects may be any one or a combination of the foregoing, or any other beneficial effects that may be obtained.

Having thus described the basic concepts, it may be rather apparent to those skilled in the art after reading this detailed disclosure that the foregoing detailed disclosure may be intended to be presented by way of example only and may be not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment may be included in at least one embodiment of the present disclosure. Therefore, it may be emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that may be not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object to be recognized oriented programming language such as Java, Scala, Smalltalk, Eiffel, JADE, Emerald, C++, C #, VB.NET, Python or the like, conventional procedural programming languages, such as the “C” programming language, Visual Basic, Fortran 2103, Perl, COBOL 2102, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local part network (LAN) or a wide part network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, may be not intended to limit the claimed processes and methods to any order except as may be specified in the claims. Although the above disclosure discusses through various examples what may be currently considered to be a variety of useful embodiments of the disclosure, it may be to be understood that such detail may be solely for that purposes, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purposes of streamlining the disclosure aiding in the understanding of one or more of the various inventive embodiments. This method of disclosure, however, may be not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein may be hereby incorporated herein by this reference in its entirety for all purposes, excepting any prosecution file history associated with same, any of same that may be inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and describe.

1. A method for extracting one or more self-created terms in a professional area, comprising:
extracting one or more candidate terms from a text;
determining first data representing an occurrence of each of the one or more candidate terms in the text;
determining one or more lemmas of the each of the one or more candidate terms;
determining second data representing an occurrence of each of the one or more lemmas in a general corpus;
determining third data representing an occurrence of each of the one or more lemmas in a professional area corpus; and
determining, based on reference data, a possibility that the each of the one or more candidate terms is a self-created term, wherein the reference data includes the first data, the second data, and the third data.

2. The method of claim 1, wherein the extracting one or more candidate terms in a text includes:
obtaining a plurality of segmented word combinations by performing word segmentation on the text;
removing, from the plurality of segmented word combinations, one or more segmented word combinations present in the professional area corpus; and
determining the one or more candidate terms from the removed segmented word combinations.

3. The method of claim 1, wherein the reference data further includes a word-class structure.

4. The method of claim 3, wherein the first data includes a first frequency, wherein the first frequency includes at least one of a frequency of the each of the one or more candidate terms in different portions of the text and a frequency of the each of the one or more candidate terms in the text.

5. The method of claim 4, wherein the first data further includes a first count, wherein the first count includes at least one of a count of the each of the one or more candidate terms in different portions of the text and a count of the each of the one or more candidate terms in the text.

6. The method of claim 5, wherein the determining, based on reference data, a possibility that the each of the one or more candidate terms is a self-created term includes: determining the possibility that the each of the one or more candidate terms is the self-created term according to a rule.

7. The method of claim 6, wherein
the second data includes a second frequency of each of the one or more lemmas in the general corpus;
the third data includes a third frequency of each of the one or more lemmas in the professional field corpus; and
the rule includes that:
the first frequency exceeds a first threshold;
the second frequency is less than a second threshold; and
a ratio of the third frequency to the second frequency exceeds a third threshold.

8. The method of claim 7, wherein the rule further includes that:
a matching degree of the word-class structure of the each of the one or more candidate terms with a preset word-class structure exceeds a fourth threshold.

9. The method of claim 1, wherein the determining, based on reference data, a possibility that the each of the one or more candidate terms is a self-created term includes: determining the possibility that the each of the one or more candidate terms is the self-created term according to a trained machine learning model.

10. The method of claim 9, wherein the trained machine learning model is obtained by a training process, wherein the training process includes:
obtaining a plurality of training samples;
extracting a plurality of features of each of the plurality of training samples; and
generating the trained machine learning model by training a preliminary machine learning model based on the plurality of features.

11. A system for extracting one or more self-created terms in a professional area, comprising an extraction module, a determination module, and a training module, wherein
the extraction module is configured to extract one or more candidate terms from a text; and
the determination module is configured to:
determine first data representing an occurrence of each of the one or more candidate terms in the text;
determine one or more lemmas of the each of the one or more candidate terms;
determine second data representing an occurrence of each of the one or more lemmas in a general corpus;
determine third data representing an occurrence of each of the one or more lemmas in a professional area corpus; and
determine, based on reference data, a possibility that the each of the one or more candidate terms is a self-created term, wherein the reference data includes the first data, the second data, and the third data.

12. The system of claim 11, wherein the extraction module is further configured to:
obtain a plurality of segmented word combinations by performing word segmentation on the text;
remove, from the plurality of segmented word combinations, one or more segmented word combinations present in the professional area corpus; and
determine the one or more candidate terms from the removed segmented word combinations.

13. The system of claim 11, wherein the reference data further includes a word-class structure.

14. The system of claim 13, wherein the first data includes a first frequency, wherein the first frequency includes at least one of a frequency of the each of the one or more candidate terms in different portions of the text and a frequency of the each of the one or more candidate terms in the text.

15. The system of claim 14, wherein the first data further includes a count of the each of the one or more candidate terms in different portions of the text and/or a count of the each of the one or more candidate terms in the text.

16. The system of claim 15, wherein the determination module is further configured to: determine the possibility that the each of the one or more candidate terms is the self-created term according to a rule.

17. The system of claim 16, wherein
the second data includes a second frequency of each of the one or more lemmas in the general corpus;
the third data includes a third frequency of each of the one or more lemmas in the professional field corpus; and
the rule includes that:
the first frequency exceeds a first threshold;
the second frequency is less than a second threshold; and
a ratio of the third frequency to the second frequency exceeds a third threshold.

18. The system of claim 17, wherein the rule further includes that:
a matching degree of the word-class structure of the each of the one or more candidate terms with a preset word-class structure exceeds a fourth threshold.

19. The system of claim 11, wherein the determination module is further configured to: determine the possibility that the each of the one or more candidate terms is the self-created term according to a trained machine learning model.

20. (canceled)

21. A system for extracting a self-created term in a professional area, comprising:
at least one storage device storing a set of instructions; and
at least one processor in communication with the at least one storage device, when executing the stored set of instructions, the at least one processor causes the system to:
extract one or more candidate terms from a text;
determine first data representing an occurrence of each of the one or more candidate terms in the text;
determine one or more lemmas of the each of the one or more candidate terms;
determine second data representing an occurrence of each of the one or more lemmas in a general corpus;
determine third data representing an occurrence of each of the one or more lemmas in a professional area corpus; and
determine, based on reference data, a possibility that the each of the one or more candidate terms is a self-created term, wherein the reference data includes the first data, the second data, and the third data.

22. (canceled)
